(19) United States
(12) Patent Application Publication
(10) Pub. No.: US 2025/0110200 A1
(43) Pub. Date: Apr. 3, 2025

(54) METHODS, SYSTEMS, AND APPARATUSES FOR PRESENCE DETECTION

(71) Applicant: Comcast Cable Communications, LLC, Philadelphia, PA (US)

(72) Inventor: James H. Stephens, JR., Austin, TX (US)

(21) Appl. No.: 18/477,976

(22) Filed: Sep. 29, 2023

(51) Int. Cl. G01S 5/02

(52) U.S. Cl. CPC G01S 5/0273

(57) ABSTRACT

Methods, systems, and apparatuses for configuring a wireless network are described herein. A wireless network may include a gateway device, one or more access points, and/or one or more client devices. The gateway device, one or more access points, and one or more client devices may be configured for WiFi motion detection. A computing device may determine a group of devices to configure for WiFi motion detection.

### BACKGROUND

Many premises, such as homes and commercial properties, implement WiFi motion detection technology on a local area network. However, current methods for configuring and implementing WiFi motion detection systems on local area networks are lacking. For example, it is not clear or intuitive to determine which devices to include in the motion detection system, and which devices should not be included. Configuration errors may lead to poor performance of the system and user frustration. These and other shortcomings are identified and addressed in the disclosure.

### SUMMARY

It is to be understood that both the following general description and the following detailed description are exemplary and explanatory only and are not restrictive. Methods, systems, and apparatuses for motion detection are described herein. A wireless network may include one or more access points (AP) and one or more client devices. Signals sent to and received from the one or more client devices or one or more access points may be analyzed to determine signal characteristic data. For example, devices one or more devices may be determined to be moving devices while one or more other devices may be determined to be stationary devices. The signal characteristic data may be used to determine a group of devices connected to the network that should be included in the motion detection system, and other devices that should not be included in the motion detection system. For example, devices that are determined to be moving may not be used, whereas devices that are determined to be stationary may be used.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows a block diagram of an example system;

FIG. 2A shows an example system;

FIG. 2B shows an example system;

FIG. 3 shows an example method;

FIG. 4 shows an example system;

FIG. 5A shows an example system;

FIG. 5B shows an example method;

FIG. 6 shows an example method;

FIG. 7 shows an example method;

FIG. 8 shows an example method;

FIG. 9 shows an example method; and

FIG. 10 shows a block diagram of an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

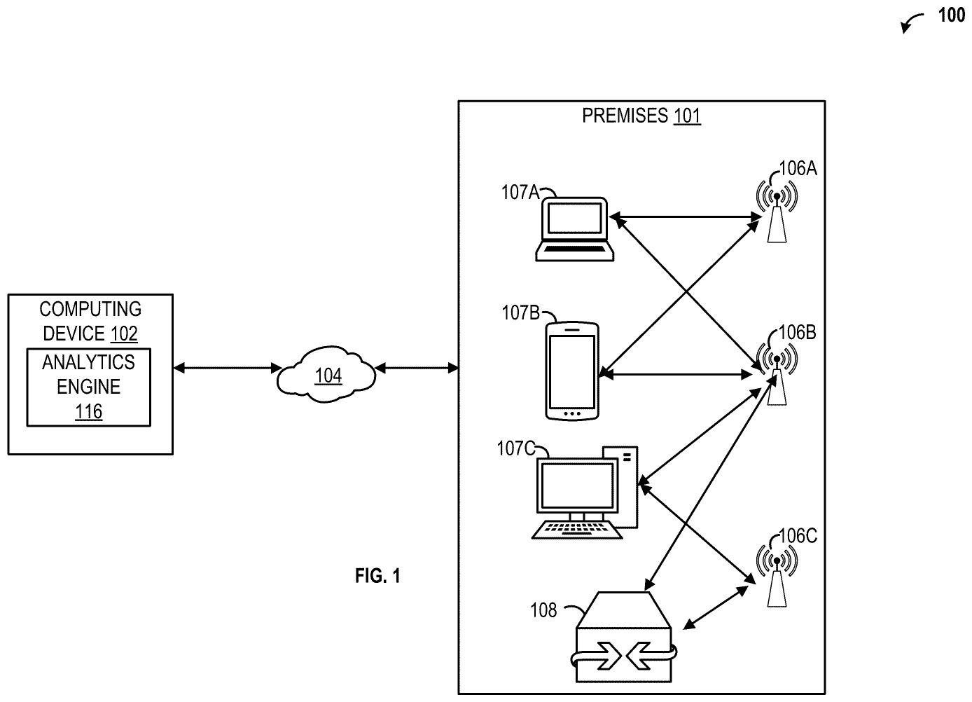

Turning now to FIG. 1, a block diagram of an example system 100 for managing a wireless network associated with a premises 101 is shown. The premises 101 may be, for example, a building (e.g., a house, a retail establishment, an office, and the like), or any other area comprising a boundary (e.g., a park, a stadium, and the like). The system 100 may comprise one or more access points, for example access points 106A, 106B. 106C. The access points 106A, 106B, 106C may be configured to provide the wireless network. The wireless network may comprise, for example, a Wi-Fi network. While three access points 106A, 106B, 106C are shown, it is understood that any number of access points may be used. For example, a single access point may be used to provide the wireless network. Each of the access points 106A, 106B, 106C may be associated with an identifier such as a service set identifier (SSID) or media access control (MAC) address.

One or more client devices (e.g., a client device 107A, a client device 107B, a client device 107C) may utilize the wireless network provided by the access points 106A. 106B, 106C to communicate with one or more other devices, to receive one or more services, and/or to otherwise interact with one or more other devices. While three client devices 107A, 107B, 107C are shown, it is understood that any number of client devices may be used. For example, a single client device (e.g., the client device 107A) may utilize the wireless network. The one or more client devices 107A, 107B, 107C may communicate over the wireless network by sending and receiving electromagnetic signals. The one or more client devices 107A, 107B, 107C may send and/or receive electromagnetic signals from and/or to the each other and/or the one or more access points 106A, 106B, 106C, and/or any other device connected to the network. The one or more client devices and one or more access points may be referred to as “network devices,” “network devices,” or the like.

The system 100 (or any one or more devices thereof), may be configured for motion detection. Motion of an object or person may be detected based on wireless signals. In some aspects, wireless signals based on a repeated wireless transmission are received at a wireless sensor device (e.g., one or more of the access points and/or one or more of the client devices) in a space. The received wireless signals are analyzed to detect movement of the object in the space. The analysis may comprise determining complex values representing the relative phases and amplitudes of respective frequency components of each of the received wireless signals, and detecting movement of an object in the space based on a change in the complex values. Any combination of the one or more devices of FIG. 1 may comprise a motion detection network. The motion detection network may include one or more sensor devices, source devices and other components. For example, a client device of the one or more client devices might be source device, and an access point of the one or access points may be the sensor device and vice versa. Similarly, an access point can be a source device and another access point the sensor device. Similar, a client device may be the source device and another client device may be the sensor device.

For example, motion may be detected based on signals (e.g., Bluetooth Beacons, Wi-Fi Beacons, other wireless beacon signals or other types of signals) that are generated within the system. In some examples, a wireless signal may propagate through an object (e.g., a wall) before or after interacting with a moving object, which may allow the object's movement to be detected without an optical line-of-sight between the moving object and the sensor device. The motion detection network may be used in larger systems, such as a security system, that may include a control center for monitoring movement within a space, such as a room, building, etc.

A communication channel for a wireless signal can include, for example, air or any other medium through which the wireless electromagnetic signal propagates. A communication channel can include multiple paths for a transmitted wireless electromagnetic signal. For a given communication channel (or a given path in a communication channel), the transmitted signal can be reflected off of or scattered by a surface in the communication channel. Reflection or scattering may occur as a result of the transmitted signal being incident upon an impedance discontinuity, which may occur at a boundary between distinct materials, such as a boundary between air and a wall, a boundary between air and a person, or other boundaries. In some instances, when a transmitted signal becomes incident upon a boundary between a first material (in this example, air) and a second material (in this example, a wall), a portion of the transmitted signal can be reflected or scattered at the boundary between the air and the wall. Additionally, another portion of the transmitted signal may continue to propagate through the wall, it may be refracted or affected in another manner. Further, the other portion that propagates through the wall may be incident upon another boundary, and a further portion may be reflected or scattered at that boundary and another portion may continue to propagate through the boundary.

At a sensor device, signals that propagate along the multiple paths of the communication channel can combine to form a received signal. Each of the multiple paths can result in a signal along the respective path having an attenuation and a phase offset relative to the transmitted signal due to the path length, reflectance or scattering of the signal, or other factors. Hence, the received signal at the sensor device can have different components that have different attenuations and phase offsets relative to the transmitted signal. When an object that reflects or scatters a signal in a path moves, a component of the received signal at the sensor device can change. For example, a path length can change resulting in a smaller or greater phase offset and resulting in more or less attenuation of the signal. Hence, the change caused by the movement of the object can be detected in the received signal.

The computing device may be configured to determine one or more signal characteristics associated with the electromagnetic signals exchanged by the access points 106A, 106B, 106C and the client devices 107A, 107B, 107C. The computing device may associate the one or more signal characteristics with the one or more network devices. The one or more signal characteristics may comprise at least one of: a signal envelope, frequency domain information, RSSI, amplitude data, phase data, a signal strength, a transmission power, a connection status, channel information, an authentication status, an authorization status, network traffic, a signal to noise ratio, a data throughput, a bit error rate, a packet error rate, a packet retransmission rate, combinations thereof, and the like.

The signal characteristics are subject to change and/or vary based on, for example, movement of any of the client devices 107A, 107B, 107C and/or the access points 106A, 106B, 106C, configuration of the client devices 107A, 107B, 107C and/or the access points 106A, 106B, 106C, type of client device and/or access point, physical characteristics associated with the premises 101 (e.g., walls between the client devices 107A, 107B, 107C and the access points 106A, 106B, 106C), environmental conditions such as storms or electromagnetic radiation, hardware or software characteristics such as the physical components of an antenna or parameters associated with software. For example, as a client device (e.g., the client device 107A) moves farther from an access point (e.g., the access point 106A), a received signal strength associated with a signal sent by the client device 107A as measured at the access point 106A will likely decrease, whereas if the client device 107A move closer to the access point, the received signal strength as measured at the access point 106A will likely increase. Similarly, when the client device 107A moves throughout the premises 101 such that at a first point in time the client device 107A has a line of sight to the access point 106A and at a second point in time there is a wall between the client device 107A and the access point 106A, the access point 106A may determine a signal characteristic associated with the signal transmitted by the client device 107A has changed (e.g., the RSSI has decreased). In a similar vein, when the client device 107A is located at a particular location inside or outside of the premises 101, or at a particular entrance point, in relation to the access point 106A, the received signal strength may have a particular value. That is to say, the signal characteristic data of the client device-AP connection may have known, persistent values at a particular location within the premises 101, for example inside a front entrance point. An event may occur which prompts the determination of a signal characteristic. For example, when the client device 107A enters the coverage area 110, a determination can be made, using the signal characteristic data, as to when and where the client device 107A entered the coverage area 110 (e.g., when a probe request is received), or when and where the client device 107A entered the premises 101.

The system 100 may comprise a gateway 108. The gateway 108 may send a signal to a computing device (e.g., the computing device 102) and, the signal characteristics of signals transmitted by the client device 107A may be determined. A device characteristic of the client device 107A may be determined. For example, it may be determined whether the client device 107A is mobile or stationary. For example, if the signal characteristic associated with the signals transmitted by the client device 107A are determined to have a particular value at a first time, and then, at a second time, the signal characteristic associated with the signal for the client device 107A is determined to have changed (e.g., the RSSI has increased or decreased), the client device 107A may be determined to be mobile.

The computing device 102 may comprise an analytics engine 116. The analytics engine 116 may determine a change in the signal characteristic associated with any of the network devices. The signal characteristics may be determined periodically. For example, the signal characteristics may be determined at regular intervals throughout a period of time such as an hour, a day, a week, a month, etc. The signal characteristics may be determined upon installation. That is to say, a user may, during installation, determine, for example for the client device 107A, the client device signal profile associated with the client device 107A by moving about the premises 101 and logging signal characteristic data at various times and locations throughout the premises 101. The analytics engine 116 may comprise hardware components and/or software components which are configured to receive and/or determine signal characteristic data associated with one or more client devices 107A, 107B, 107C and/or one or more access points 106A, 106B, and 106C connected to the wireless network (e.g., the “network devices” or “networked devices”) so as to determine signal a client device signal profile and/or a wireless network signal profile. The signal characteristic data may be determined based on inbound or outbound signals received or sent by the one or more client devices and/or the one or more access points. For example, the signal characteristic data (e.g., signal envelope, frequency domain information, amplitude, phase, signal quality, RSSI, or any physical property or digital property of the signals, combinations thereof, and the like) may be determined by any of the one or more client devices, any of the one or more access points, and/or by the computing device.

The signal characteristic data may comprise values (e.g., absolute or relative values associated with transmission power, received signal strength, traffic levels, or combinations thereof, and the like) associated with the signal characteristics as well as one or more results of operations performed on the signal characteristics. The signal characteristic data may comprise temporal information associated with the signal characteristics. The temporal information may comprise, for example, a timestamp, a date, an indication of a time period, combinations thereof, and the like. The signal characteristic data may comprise one or more identifiers associated with the signal characteristics. The one or more identifiers may be associated with any device that sent or received a signal from which the signal characteristic was determined. For example, an identifier of the client device 107A, an identifier of an access point 106A, combinations thereof, and the like. For example, the identifier may comprise a media access control (MAC) address, an Internet Protocol (IP) address, an international mobile subscriber identifier (IMSI), an international mobile equipment identity (IMEI), a serial number, a device name, combinations thereof, and the like. The signal characteristic data may comprise location information associated with the signal characteristics. For example, the location information may comprise GPS coordinates. The location information may comprise relative location information such as the location of a client device as determined by triangulating a distance between the client device 107A and a plurality of access points 106A, 106B, 106C.

In an embodiment, the client devices 107A, 107B, 107C may be configured to determine the signal characteristic data. The client devices 107A, 107B, 107C may be configured to determine the signal characteristic by receiving an electromagnetic signal via an antenna. The antenna may be configured to transmit the electromagnetic signal to a transducer. The transducer may be configured to convert the analog electromagnetic signal into a digital signal suitable for processing and analysis. The client devices 107A, 107B, 107C may be configured to send any determined signal characteristics and/or signal characteristic data to the access points 106A, 106B, 106C and/or to a remote device (e.g., the computing device 102).

In an embodiment, the access points 106A, 106B. 106C may be configured to determine the signal characteristic. For example, the access points 106A, 106B, 106C may be configured to receive an electromagnetic signal (e.g., an electromagnetic wave) from client devices 107A, 107B, 107C via an antenna. The antenna may be configured to transmit the electromagnetic signal to a transducer. The transducer may be configured to convert the electromagnetic signal into a digital signal suitable for analysis and processing. The access points 106A, 106B, 106C may be configured to send any determined signal characteristics and/or signal characteristic data to a remote device (e.g., the computing device 102).

The computing device 102 may be configured to determine a client device signal profile based on the signal characteristic data. The wireless network signal profile data may comprise, for example, one or more of: signal envelope, propagation characteristics, phase, amplitude, RSSI, a signal strength, a transmission power, a connection status, channel information, an authentication status, an authorization status, network traffic, a signal to noise ratio, a data throughput, a bit error rate, a packet error rate, a packet retransmission rate, combinations thereof, and the like for any given device connected to the wireless network including access points 106A, 106B, 106C and client devices 107A, 107B, 107C. For example, upon installation, and/or over the course of time, the computing device 102 may determine the signal characteristic data associated with the client device 107A so as to build the client device signal profile. For example, the analytics engine 116 may determine the RSSI of the client device 107A has relatively constant value of −30 dBm with respect to the one or more access points (e.g., the access point 106A and/or with respect to access point 106B). The analytics engine 116 may determine, for each client device of the client devices 107A, 107B, 107C, the client device signal profile. The analytics engine 116 may determine, for the one or more APs and client devices 107A, 107B, 107C, the wireless network signal profile associated with the premises 101. The analytics engine 116 may collect/aggregate/analyze signal characteristic data related to each of the client devices 107A, 107B, 107C.

In a similar fashion, the analytics engine 116 may determine the signal characteristic associated with the client device 107A is variable, but strong, Monday through Friday, between the hours of 7:00 AM and 9:00 PM (e.g., the client device 107A is connected to the wireless network and moving around the premises 101, perhaps staying in one location for periods of time because 107A is a shared laptop or similar circumstances). For example, when the client device 107A enters the coverage area, the analytics engine 116 may determine an initial RSSI associated with the client device 107A. As the initial RSSI associated with the client device 107A increases, the analytics engine 116 may determine a distance between the client device 107A and, for example, the access point 106A is decreasing and thus, the analytics engine 116 may determine the client device 107A is approaching the access point.

For example, the RSSI for the client device 107B may vary with respect to time throughout the day. The varying RSSI may correspond to movement of the client device 107B with respect to the one or more access points. For example, the client device 107B may send a signal (e.g., the probe request) to the access point 106A at 9:00 AM wherein the signal associated with the client device 107B comprises an RSSI of −30 dBm. At 9:01 AM, the RSSI associated with the client device 107B may be determined to be −40 dBm with respect to the same access point. At 9:02 AM, the RSSI associated with the client device 107B may be determined to be −67 dBm with respect to the same access point and thus, the client device 107B may be determined to be a non-stationary device and thus not included in the motion detection network.

For example, during the course of a week, the analytics engine 116 may determine that the client device 107B is usually not connected to the wireless network between Monday and Friday and between the hours of 10:00 AM and 5:00 PM (e.g., the client device 107B is at a location other than the premises 101).

Meanwhile, signal characteristics associated with the client device 107C (the desktop computer) may remain relatively constant throughout the day. For example, the client device 107C may be a stationary device (e.g., desktop computer, a set-top box, media player, smart speaker, connected device (e.g., an IoT device), combinations thereof, and the like etc.), and the level of RSSI may remain relatively static (e.g., constant) throughout the day.

The client device signal profile may comprise the signal characteristic data, changes in the signal characteristic data, or operations performed thereon. For example, the analytics engine 116 may determine, over a period of time, signal characteristic data associated with the client device 107A as received by the AP 106A. The analytics engine 116 may determine changes in the signal characteristic data over time, for example various signal strengths associated with various times and/or locations. The client device signal profile may also comprise an identifier associated with the client device 107A, such as a MAC address. The client device 107A associated with the MAC address may be a known client device. The client device signal profile may also comprise temporal information such as the time at which a signal was received by an AP 106A.

The computing device 102 may be configured to determine a wireless network signal profile by determining signal characteristic data associated with the access points 106A. 106B, 106C and client devices 107A, 107B, 107C connected to the wireless network. For example, the computing device 102 may determine the wireless network signal profile by determining one or more signal characteristics associated with one or more wireless signals sent or received by the network devices. For example, it may be determined that at 3:00 AM every morning, one or more signal characteristics (e.g., signal envelope, propagation characteristics, phase, amplitude, RSSI, combinations thereof, and the like) for the one or more client devices and one or more access points are relatively constant. In other words, at 3:00 AM every morning, the one or more client devices and one or more access points (e.g., the network devices) are stationary. It may also be determined that at 9:00 AM in morning, the RSSI associated with the client device 102B (a mobile phone) begin to change as that device moves about the premises 101.

The computing device 102 may be configured to receive and/or determine signal characteristic data associated with an unknown client device. For example, when the unknown client device is determined to be in range of the wireless network or attempts to connect to the wireless network, the unknown client device may transmit a signal to, for example, the access point 106A. The signal may comprise, for example, a probe request. The probe request may comprise an identifier associated with the unknown client device. The access point 106A may send information related to the signal to the analytics engine 116 which may determine the signal characteristic data. The unknown client device may be a device which is not associated with the premises 101, for example, a mobile phone associated with a neighboring premises. The unknown client device may not be associated with a known client device signal profile.

It may be determined that a user device (e.g., one of the client devices) has left the premises. Based on determining the user has left the premises, the motion detection network may be armed or disarmed. For example, based on one or more signal characteristics associated with a user device, it may be determined that the user device is no longer within a coverage area, no longer within a premises, no longer connected to a network, combinations thereof, and the like. Based on determining the user device has left the premises, the motion detection network can be armed automatically.

An action may be caused based on detecting motion. For example, if motion is detected 101, an alarm may be initiated or an exterior lighting setting may be implemented. For example, a message may be sent. For example, the message may comprise an alarm message configured to cause one or more security actions (e.g., dispatch personnel from a security service, place a call to a public safety entity, combinations thereof, or the like. A message may be sent to the user device. The message may timing information and information related to the motion detection event. The information related to the motion detection event may comprise timing information, location information (e.g., wherein the premises the motion event occurred), device information (e.g., which device(s) detected the motion event), an event type (e.g., a human fall vs. a pet on patrol vs. an intruder). The message may comprise an option. For example, the message may comprise the disarm option, the alarm option, the trust option, or some similar option which may allow the user to confirm or deny the presence of the unknown device and take further action. The aforementioned examples are merely explanatory and are not intended to be limiting. It is to be understood that, upon determining the status of the unknown client device, any action may be caused. For example, the action may relate to security systems or settings, media content systems or settings, internet connectivity systems or settings, combinations thereof, and the like.

The computing device 102 may be, for example, a server. The server may be associated with a service provider such as an Internet service provider, a security service provider, or the like. The computing device 102 may be disposed locally or remotely. The computing device 102 may communicate with the access points 106A, 106B, 106C and/or the client devices 107A, 107B, 107C via a network 104. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof.

The computing device 102 may be configured to provide services such as network (e.g., Internet) connectivity services, security services, content services, or other network-related services. Internet connectivity services may comprise, for example, providing access to a communications network such as the Internet through, for example, hardwired broadband access such as dial-up access, multilink dial-up, integrated services digital networks, leased lines, cable internet access, digital subscriber lines, fiber optic networks, wireless broadband access such as satellite, mobile, WiMAX, wireless ISP or local multipoint distribution, hybrid access networks, packet radio, combinations thereof, and the like. Security services may comprise for example hardware such as sensors (window sensors, door sensors, motion detectors, control panels, electronic keypads, etc.) as well as software such as alarm software and accompanying communications software. For example, security services may comprise sending notifications, alerts, or other messages. For example, security services may comprise activating cameras, recording video, initiating alarms, triggering lighting devices or audio devices, combinations thereof, and the like. Content services may comprise providing content via streaming services, cable television, broadcast television, satellite television, video-on-demand, combinations thereof, and the like. Media services may also refer to social media services such as connectivity and interaction with social media platforms such as Facebook®, Twitter®, Snapchat®, Instagram®, TikTok®, combinations thereof, and the like. For example, the computing device 102 may allow the client devices 107A, 107B, 107C to interact with remote resources such as data, devices, files, security resources, or the like. The computing device 102 may be configured as (or disposed at) a central location (e.g., a headend, or processing facility), which may receive content (data, programming or the like), from multiple sources.

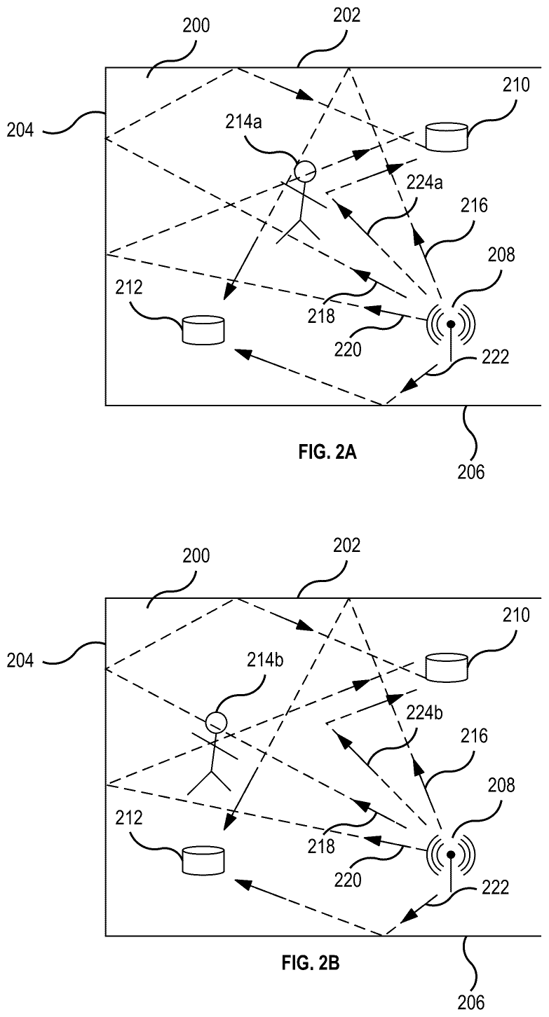

FIGS. 2A and 2B are diagrams showing signals transmitted in a space 200 that includes an example motion detection system. The example space 200 can be completely or partially enclosed or open at one or more boundaries of the space. The space 200 can be or can include an interior of a room, multiple rooms, a building, or the like. A first wall 202, a second wall 204, and a third wall 206 at least partially enclose the space 200 in the example shown.

The example motion detection system includes a source device 208, a first sensor device 210 and a second sensor device 212 in the space 200. The source device 208 is operable to transmit a transmitted wireless signal (e.g., an RF wireless signal) repeatedly (e.g., periodically, intermittently, at random intervals, etc.). The sensor devices 210, 212 are operable to received wireless signals (e.g., RF wireless signals) based on the transmitted wireless signal. The sensor devices 210, 212 each have a processor that is configured to determine characteristics (e.g., relative phase and magnitude) of frequency components of respective signals based on the received wireless signals. The sensor devices 210, 212 each have a processor that is configured to detect motion of an object based on a comparison of the characteristics of the frequency components.

As shown, an object is in a first position 214a in FIG. 2A, and the object has moved to a second position 214b in FIG. 2B. In FIGS. 2A and 2B, the moving object in the space 200 is represented as a human, but the moving object can be another type of object. For example, the moving object can be an animal, an inorganic object (e.g., a system, device, apparatus or assembly), or object that defines all or part of the boundary of the space 200 (e.g., a wall, door, window, etc.), or another type of object.

As shown in FIGS. 2A and 2B, multiple example paths of a wireless signal transmitted from the source device 208 are illustrated by dashed lines. Along a first signal path 216, the wireless signal is transmitted from the source device 208 and reflected off the first wall 202 toward the second sensor device 212. Along a second signal path 218, the wireless signal is transmitted from the source device 208 and reflected off the second wall 204 and the first wall 202 toward the first sensor device 210. Along a third signal path 220, the wireless signal is transmitted from the source device 208 along a third path and reflected off the second wall 204 toward the first sensor device 210. Along a fourth signal path 222, the wireless signal is transmitted from the source device 208 and reflected off the third wall 206 toward the second sensor device 212.

In FIG. 2A, along a fifth signal path 224a, the wireless signal is transmitted from the source device 208 and reflected off the object at the first position 214 a toward the first sensor device 210. Between FIGS. 2A and 2B, a surface of the object moves from the first position 214a to a second position 214b in the space 200 some distance away from the first position 214a. In FIG. 2B, along a sixth signal path 224b, the wireless signal is transmitted from the source device 208 and reflected off the object at the second position 214b toward the first sensor device 210. The sixth signal path 224 b depicted in FIG. 2B is longer than the fifth signal path 224 a depicted in FIG. 2A due to the movement of the object from the first position 214 a to the second position 214b. In some examples, a path to a sensor can be added, removed or otherwise modified due to movement of an object in a space.

The example signals shown in FIGS. 2A and 2B may experience attenuation, frequency shifts, phase shifts or other effects through their respective paths and may have portions that propagate in another direction, for example, through the walls 202, 204, and 206. In some examples, the signals are radio frequency (RF) signals; or the signals may include other types of signals.

As shown in FIGS. 2A and 2B, the source device 208 repeatedly transmits a signal. In particular, FIG. 2A shows the signal being transmitted from the source device 208 at a first time, and FIG. 2B shows the same signal being transmitted from the source device 208 at a second, later time. The transmitted signal can be transmitted continuously, periodically, at random or intermittent times or the like, or a combination thereof. The transmitted signal can have a number of frequency components in a frequency bandwidth. The transmitted signal can be transmitted from the source device 208 in an omnidirectional manner, in a directional manner or otherwise. In the example shown, the signals traverse multiple respective paths in the space 200, and the signal along each path may become attenuated due to path losses, scattering, reflection, or the like and may have a phase or frequency offset.

As shown in FIGS. 2A and 2B, the signals from various paths 216, 218, 220, 222, 224 a, and 224 b combine at the first sensor device 210 and the second sensor device 212 to form received signals. Because of the effects of the multiple paths in the space 200 (an example communication channel) on the transmitted signal, the space 200 may be represented as a transfer function (e.g., a filter) in which the transmitted signal is input and the received signal is output. When an object moves in the space 200, the attenuation or phase offset affected upon a signal in a signal path can change, and hence, the transfer function of the space 200 can change. Assuming the same transmitted signal is transmitted from the source device 208, if the transfer function of the space 200 changes, the output of that transfer function—the received signal—will also change. A change in the received signal can be used to detect movement of an object.

Mathematically, a transmitted signal f(t) transmitted from the source device 208 may be described according to Equation (1):

$$f ( t ) = {\sum }_{n} ( {c}_{n} e \hat{} ( j {ω}_{n} t ) )$$

where ωn represents the frequency of nth frequency component of the transmitted signal, cn represents the complex coefficient of the nth frequency component, and t represents time. With the transmitted signal f(t) being transmitted from the source device 208, an output signal rk(t) from a path k may be described according to Equation (2):

$${r}_{k} ( t ) = {\sum }_{n} ( {α}_{nk} {c}_{n} e \hat{} ( j ( {ω}_{n} t + {ϕ}_{nk} ) ) )$$

where αn,k represents an attenuation factor (e.g., due to scattering, reflection, and path losses) for the nth frequency component along path k, and φn,k represents the phase of the signal for nth frequency component along path k. Then, the received signal R at a sensor device can be described as the summation of all output signals rk(t) from all paths to the sensor device, which is shown in Equation (3):

$$R = {\sum }_{k} {r}_{k} ( t )$$

Substituting Equation (2) into Equation (3) renders the following Equation (4):

$$R = {\sum }_{k} {\sum }_{n} = ( {α}_{nk} e \hat{} ( j {ϕ}_{n , k} ) ) {c}_{n} e \hat{} ( j {ω}_{n} t )$$

The received signal R at a sensor device can then be analyzed. The received signal R at a sensor device can be transformed to the frequency domain, for example, using a Fast Fourier Transform (FFT) or another type of algorithm. The transformed signal can represent the received signal R as a series of n complex values, one for each of the respective frequency components (at the n frequencies ωn). For a frequency component at frequency on, a complex number Yn may be represented as follows in Equation (5):

$${Y}_{n} = {\sum }_{k} {c}_{n} {α}_{nk} e \hat{} ( j {ϕ}_{nk} )$$

The complex value Yn for a given frequency component ωn indicates a relative magnitude and phase offset of the received signal at that frequency component ωn.

With the source device 208 repeatedly (e.g., at least twice) transmitting the transmitted signal f(t) and a respective sensor device 210 and 212 receiving and analyzing a respective received signal R, the respective sensor device 210 and 212 can determine when a change in a complex value Yn (e.g., a magnitude or phase) for a given frequency component ωn occurs that is indicative of movement of an object within the space 200. For example, a change in a complex value Yn for a given frequency component on may exceed a predefined threshold to indicate movement. In some examples, small changes in one or more complex values Yn may not be statistically significant, but may only be indicative of noise or other effects.

In some examples, transmitted and received signals are in an RF spectrum, and signals are analyzed in a baseband bandwidth. For example, a transmitted signal may include a baseband signal that has been up-converted to define a transmitted RF signal, and a received signal may include a received RF signal that has been down-converted to a baseband signal. Because the received baseband signal is embedded in the received RF signal, effects of movement in the space (e.g., a change in a transfer function of the communication channel) may occur on the received baseband signal, and the baseband signal may be the signal that is analyzed (e.g., using a Fourier analysis or another type of analysis) to detect movement. In other examples, the analyzed signal may be an RF signal or another signal.

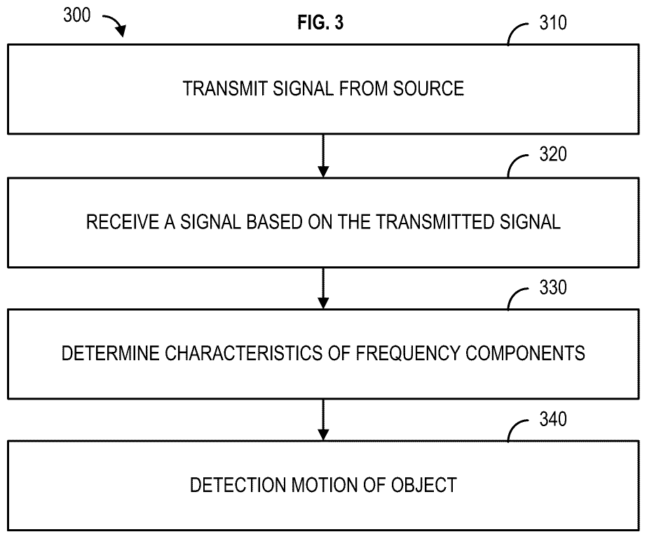

FIG. 3 is a flowchart showing an example process for detecting movement in a space. The example process shown in FIG. 3 may include additional or different operations, and the operations can be performed in the order shown or in another order. In some implementations, the process shown in FIG. 3 can be performed by a motion detection system such as, for example, the motion detection systems shown in FIGS. 2A and 2B. In some implementations, the process shown in FIG. 3 can be performed by another type of system that includes similar or different components.

At 310, a wireless signal is transmitted from a source, which produces a transmitted wireless signal in a space. The transmission is performed repeatedly. Referring back to FIGS. 2A and 2B, for example, the source device 208 can repeatedly send a transmitted wireless signal. In some implementations, the transmission can be a beacon signal that is repeatedly sent by a Bluetooth device, a Wi-Fi router, or another type of device. The repeated transmissions can be sent at scheduled times, at periodic or random intervals or in other time steps. In some cases, the transmitted wireless signal is multiple times per second, per minute, per hour, etc.

At 320, a wireless signal is received at a sensor in the space; the received wireless signal is based on the transmission of the transmitted wireless signal. As shown in FIG. 3, wireless signals can be received repeatedly, such that, for example, a signal can be received at 302 for each transmission at 300. Referring back to the example shown in FIGS. 2A and 2B, the first sensor device 210 repeatedly receives a wireless signal—at a first time in FIG. 2A, and at a second time in FIG. 2B.

At 330, characteristics of frequency components of the received wireless signal are determined. As discussed above in the example of FIGS. 2A and 2B, the received signals can be transformed (e.g., Fourier transformed) to the frequency domain to determine complex values representing the frequency components in a bandwidth of the signal. The analysis can be performed for each of the received wireless signals.

At 340, movement of an object in the space is detected based on the characteristics of the frequency components of multiple received wireless signals. For example, in the example of FIGS. 2A and 2B, when a complex value representing a magnitude and phase of a frequency component of a received signal changes by an amount that exceeds a threshold value, movement can be detected.

In an example implementation of the process shown in FIG. 3, at a first time t₁, the source device 208 sends a first transmission T₁ of a signal S; the first sensor device 210 then receives a first wireless signal R₁ based on the first transmission T₁. At a second, later time t₂, the source device 208 sends a second transmission T₂ of the same signal S; the first sensor device 210 then receives a second wireless signal R₂ based on the second transmission T₂. In this example, the first and second transmissions (T₁ and T₂) from the source device 208 are the same wireless signal (S=f(t)), transmitted at different times. The received wireless signals (R₁ and R₂) may be the same or different. For example, when there is no movement of objects in the path traversed by the first and second transmissions (T₁ and T₂) between the transmission times (t₁ and t₂), the received wireless signals (R₁ and R₂) are the same; whereas movement of an object in a path between the transmission times (t₁ and t₂) may cause a difference in the received wireless signals (R₁ and R₂). Accordingly, the sensor device 210 can detect movement of objects along any signal path between the source device 208 and the sensor device 210 based on a comparison between the received wireless signals (R₁ and R₂).

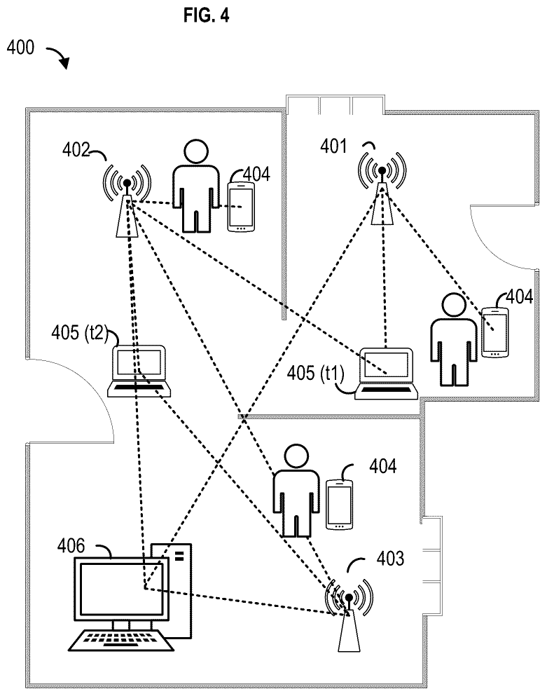

FIG. 4 shows an example system 400 in which the methods and systems described herein may operate. The system 400 may incorporate any of the devices or networks described herein. The system 400 may comprise a premises. The premises may be, for example, the premises 101. The system 400 may comprise one or more access points 401, 402, 403 (e.g., access points 106A, 106B, 106C). The one or more access points 401, 402, 403 may provide network connectivity for a wireless network for one or more client devices 404, 405, 406 (e.g., the client devices 107A, 107B, 107C).

The system 400 may be configured for motion detection as described herein. The system 400 may be configured to determine device characteristics based on signal analysis of one or more signals transmitted and/or received by the one or more devices of the system 400. For example, a computing device (e.g., a gateway, a server, combinations thereof, and the like) which may or may not be located on the premises (and is not pictured) but is nonetheless connect to a network associated with the premises, can be configured to determine whether or not the one or more client devices are stationary or mobile. For example, client device 404 is a cell phone, client device 405 is a laptop, and client device 406 is a desktop computer.

For example, when the cell phone 404 enters the premises, it may connect to the access point 401 at a first time. The cell phone 404 may be carried by a user. As the user moves about the premises (with the cell phone 404), the cell phone 404 connects next to access point 402 at a second time, and then to access point 403 at a third time. Between the first time and the second time, one or more signal characteristics associated with one or more signals to the access point 401, 402, and/or 403, may change. For example, an RSSI value may change, a signal envelope (e.g., frequency characteristics) may change, amplitude or phase data associated with the one or more signals sent between and received by the cellphone 404 and the three access points may change, combinations thereof, and the like. A computing device may analyze these changes and determine that the cell phone is not a stationary device (at least not while it is moving about the premises with the user). The computing device may determine, because the cell phone 404 is not a stationary device, that the cell phone 404 should not be included in a network configured to detect motion. However, there may be periods of time during which the cell phone 404 is stationary. For example, the cell phone may spend every night on a nightstand charging for many hours. The computing device may determine that at times, the cell phone 404 is a stationary device, and thus may include the cell phone 404 in the network configured to detect motion.

For example, the computing device may determine the desktop computer 406 is always stationary. The computing device may determine the desktop computer 406 is stationary by analyzing one or more wireless signals sent to or received by the desktop computer 406 and/or one or more wireless signals associated with the desktop computer 406 sent to and/or received from the access points 401, 402, and/or 403. For example, the desktop computer 406 may be associated with (e.g., may exhibit) a relatively uniform signal envelope, RSSI, amplitude and/or phase information. Based on determining the desktop 406 is always stationary, the computing device may include the desktop computer 406 in the motion detection network.

For example, the computing device may determine that the laptop 405 is sometimes stationary and sometimes not stationary. Based thereon, the computing device may include the laptop in the motion detection network when the laptop 405 is stationary, but not included the laptop 405 in the motion detection network when the laptop 405 is not stationary.

The computing device may be configured to determine one or more independent devices of the one or more access points and/or one or more client devices. Determining one or more independent devices may comprise determining one or more independently triggered devices, determining one or more geographically disperse devices, determining one or more independent device types, combinations thereof, and the like.

For example, determining one more independently triggered devices may comprise receiving one or more motion indications from the devices on the network and determining, based on the one or more motion indications, one or more devices that do not tend to indicate motion at the same time (and ostensibly, not for the same motion event). For example, the computing device can learn a set of devices with a maximal number of statistical components using a dimensionality reduction algorithm such as principle component analysis or similar or related techniques. For example, in order to avoid unnecessary computational (and radio) resource consumption, the system can opportunistically use data it gathers during routine signal monitoring a current set of devices. The system may be configured to determine a change in dimensionality (e.g., a drop in dimensionality).

Two devices may be considered independent if, informally, the occurrence of a motion event (e.g., and detection thereof by a first device) does not affect the probability of occurrence of a motion event, and detection thereof by a second device. Independent contemplates pairwise independent and mutual independence (e.g., collective independence). Determining the independence of two devices may comprise one or more multivariate statistical methods and multivariate signal analysis techniques such as multivariate regression, principal component analysis (PCA), independent component analysis (ICA), factor analysis, and multivariate time series analysis, source separation, blind signal separation, blind source separation, combinations thereof, and the like. For example, the Minimization-of-Mutual information (MMI) family of ICA algorithms may be employed (e.g., Kullback-Leibler Divergence and maximum entropy).

Determining one or more geographically disperse devices may comprise determining one or more devices which do not lie on the same line of sight with respect to another device. For example, it may be determined that the laptop 405, with respect access point 402, at the time t1, does not share a line of sight with any other devices. The same can be said of cell phone 404 and desktop 406. However, at time t2, the laptop lies on a line of sight between the desktop and the access point 402. Thus, at time t2, the laptop may not be included in the motion detection network.

For example, it may be desirous to include in the motion detection network a diversity of device types so as protect against security threats and/or hardware or software failures. To that end, the computing device may determine devices connected to the network that exhibit different signal properties (e.g., different signal envelopes, amplitude and phase profiles, combinations thereof, and the like) to be included in the motion detection network.

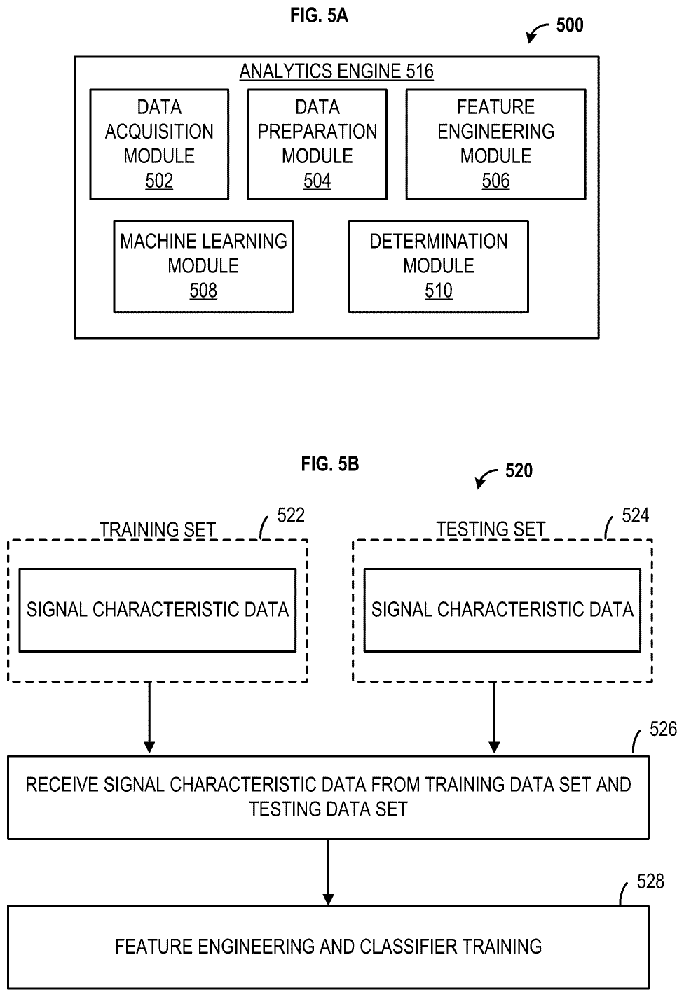

FIG. 5A shows an expanded block diagram of the analytics engine 516 of FIG. 5. The analytics engine 516 may be used to manage or monitor the wireless network at the premises 501 and to monitor signal characteristic data associated with the access points and/or client devices. While the following description of the analytics engine 516 may describe only one client device or access point for case of explanation, it is to be understood that the functionality of the analytics engine 516 and its implementation of the methods described herein may apply to any of the one or more client devices or access points in communication with the wireless network. The analytics engine 516 may determine the client device signal profile within a coverage area of the wireless network as described herein. The client device signal profile may comprise signal characteristic data collected/aggregated by a data acquisition module 502. The signal characteristic data collected/aggregated by the data acquisition module 502 may require cleaning/preparation in order to make the signal characteristic data more useful for the analytics engine 516.

The analytics engine 516 may include a data preparation module 504 that may be configured for initial cleaning of the signal characteristic data and for generating intermediate data staging and temporary tables in a database of the data preparation module 504. For example, the data preparation module 504 may clean the signal characteristic data by removing duplicate records in the database for a given client device (e.g., the client device 107A), a given AP (e.g., the access point 106A), and/or the wireless network when multiple entries for the client device 107A, AP 106A, and/or the wireless network are present in the signal characteristic data. The data preparation module 504 may also eliminate any values of signal characteristics (e.g., based on a signal characteristic(s)) that are present within the signal characteristic data less than a threshold amount of times). For example, values of signal characteristics having ten or fewer occurrences within the signal characteristic data may not contribute significantly towards assisting with a determination option as to whether or not a given device is inside or outside of the boundary of the premises 501. For example, the data preparation module 504 may divide the signal characteristic data into multiple subsets based on a respective identifier or signal characteristic for each of the one or more client devices and/or each of the one or more APs. The data preparation module 504 may store each subset in a different table in the database.

The data preparation module 504 may standardize the signal characteristic data. For example, one or more of the subsets of the signal characteristic data may include signal characteristic data in a first format or structure while one or more other subsets of the signal characteristic data may include data in another format or structure. The data preparation module 504 may standardize the signal characteristic data by converting all data of all subsets of the signal characteristic data into a common format/structure.

The data preparation module 504 may determine one or more values of the signal characteristics based on the signal characteristic data. For example, the data preparation module 504 may determine the one or more values of the signal characteristics based on a signal characteristic for the one or more client devices and/or the one or more APs of the wireless network during a given time interval. The signal characteristic values may include one or more derived values associated with one or more signal characteristics associated with, for example the client 107A or the access point 106A. For example, a derived value of the one or more derived values may be an average level of signal strength for the client device 107A during a plurality of time intervals. For example, the derived value may be an indication of how a level of signal strength for the client device 107A for a given time interval deviates from an average level of signal strength for the client device 107A during the plurality of time intervals (e.g., a standard deviation). An example of the derived value may be a measure of a symmetry of a distribution of signal strengths for the client device 107A or access point 106A during each of the plurality of time intervals with respect to the average level of signal strength for the client device 107A or the access point 106A during the plurality of time intervals (e.g., a skewness).

The analytics engine 516 may include a feature engineering module 506 that may be configured to prepare signal characteristic data for input into a machine learning module 508 of the analytics engine 516. For example, the feature engineering module 506 may generate a data point for each client device of the wireless network using corresponding signal characteristic data. A given data point for a given client device (e.g., the client device 107A) or access point (e.g., the access point 106A) may be referred to as a “vector” of signal characteristic data that represents all relevant signal characteristic values for the client device 107A or the access point 106A. The feature engineering module 506 may be configured to perform feature engineering as part of generating the one or more machine learning models by the machine learning module 508. The feature engineering module 506 may generate new independent variables/features or modify existing features that can improve a determination of a target variable (e.g., whether the client device 107A is likely stationary or mobile, and/or is likely an independent device as described herein). The feature engineering module 506 may eliminate feature values that do not have significant effect on the target variable. That is, the feature engineering module 506 may eliminate feature values that do not have significant effect when determining whether the client device 107A is likely stationary/mobile or an independent or related device. For example, the signal characteristic data may be analyzed according to additional feature selection techniques to determine one or more independent variables/features that have a significant effect when determining whether the client device 107A is stationary/mobile and/or independent/dependent. Any suitable computational technique may be used to identify the one or more independent variables/features using any feature selection technique such as filter, wrapper, and/or embedded methods. For example, the one or more independent variables/features may be selected according to a filter method, such as Pearson's correlation, linear discriminant analysis, analysis of variance (ANOVA), chi-square, combinations thereof, and the like. For example, the one or more independent variables/features may be selected according to a wrapper method configured to use a subset of features and train a machine learning model using the subset of features. Based on inferences that may be drawn from a previous model, features may be added and/or deleted from the subset. Wrapper methods include, for example, forward feature selection, backward feature elimination, recursive feature elimination, combinations thereof, and the like. For example, the one or more independent variables/features may be selected according to an embedded method that may combine the qualities of the filter and wrapper methods. Embedded methods include, for example, Least Absolute Shrinkage and Selection Operator (LASSO) and ridge regression which implement penalization functions to reduce overfitting.

The feature engineering module 506 may also group and categorize each of the access points or the client devices, for instance as being stationary or mobile, or independent or related. For example, mobile client devices, such as laptops, mobile phones, etc., may be associated with signal characteristic data that vary greatly throughout a plurality of time intervals (e.g., based on movement of the mobile client devices with respect to, for example, access point 106A) and at times indicate the client devices are mobile as opposed to stationary. In contrast, stationary client devices, such as desktops, smart speakers, certain IoT devices, etc., may be associated with signal characteristic values that do not vary greatly throughout a plurality of time intervals and thus are consistently grouped as being stationary.

A machine learning module 508 may be configured to generate one or more machine learning models to manage and/or monitor the wireless network, access points, and/or client devices. For example, a first machine learning model may be a binary classifier that indicates whether a given client device (e.g., the client device 107A) is a stationary device. For example, a second machine learning model may be an unsupervised model (e.g., no related variables/labels are used). The second machine learning model may be used to determine whether the client device 107A of the wireless network is likely stationary or mobile, and/or independent or related. The second machine learning model may provide a prediction of whether the client device 107A is inside stationary or mobile, and/or independent or causally related. The prediction may range between 0 and 5. A value of ‘1’ may indicate the client device 107A is likely stationary, while a value of ‘0’ may indicate the client device 107A is likely mobile.

The machine learning model may include parameters, such as a plurality of signal characteristic values that are optimized by the machine learning module 508 for maximizing a function associated with the machine learning model given the signal characteristic data. For example, in the context of classification, the machine learning model may be visualized as a straight line that separates the signal characteristic data into two classes (e.g., labels indicating “stationary” or “mobile”, and/or “independent” or “related”). The function may consider a number of misclassified points of signal characteristic data. The misclassified points may be a plurality of data points (e.g., one or more signal characteristic values) that the machine learning model incorrectly classifies as not being stationary or independent. A learning process of the machine learning model may be employed by the machine learning module 508 to adjust coefficient values for the parameters such that the number of misclassified points is minimal. After this optimization phase (e.g., learning phase), the machine learning model may be used to classify new data points.

The machine learning module 508 may employ one or more machine learning algorithms such as, but not limited to, a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic or other regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like.

The machine learning module 508 may include any number of machine learning models to perform the techniques herein, such as for cognitive analytics, predictive analysis, and/or trending analytics as known in the art. The machine learning module 508 may take empirical data as an input and recognize patterns within the data. As an example, the empirical data may be signal characteristics or signal characteristic data for the wireless network, any of the access points or the client devices. The signal characteristic data may include a plurality of signal characteristic values determined by the feature engineering module 506. For example, the values may be aggregated measures from client devices 107A, 107B, 107C of the wireless network. The machine learning module 508 may employ one or more supervised, unsupervised, or semi-supervised machine learning models. Generally, supervised learning entails the use of a training set of data as discussed herein that may be used to train the machine learning model to apply labels to the input data. For example, the training data may include signal characteristic data containing a plurality of data points (e.g., signal characteristic values) that may be associated with labels indicating whether a device is stationary or mobile, and/or independent or related to other devices. Unsupervised techniques, on the other hand, do not require a training set of labels. While a supervised machine learning model may determine whether previously seen patterns in a training dataset have been correctly labeled in a testing dataset, an unsupervised model may instead determine whether there are sudden changes in values of the plurality of data points. Semi-supervised machine learning models take a middle ground approach that uses a greatly reduced set of labeled training data as known in the art.

As discussed herein, the machine learning module 508 may be configured to train a classifier of a machine learning model(s) that may be used to classify whether a signal characteristic value is indicative of, for example, an access point or client device being stationary or mobile, and/or independent or related. The machine learning module 508 may receive a training dataset that includes wireless network signal characteristic data for one or more client devices and/or one or more access points connected to the wireless network to be used to train the classifier. When training the classifier, the machine learning module 508 may evaluate several machine learning algorithms using various statistical techniques such as, for example, accuracy, precision, recall, F1-score, confusion matrix, receiver operating characteristic (“ROC”) curve, and/or the like. The machine learning module 508 may also use a Random Forest algorithm, a Gradient Boosting algorithm, an Adaptive Boosting algorithm, K-Nearest Neighbors algorithm, a Naïve Bayes algorithm, a Logistic Regressor Classifier, a Support Vector machine, a combination thereof and/or the like when training the classifier. Gradient Boosting may add predictors to an ensemble classifier (e.g., a combination of two or more machine learning models/classifiers) in sequence to correct each preceding prediction (e.g., by determining residual errors). The K-Nearest Neighbors algorithm may receive each data point within the signal characteristic data and compare each to the “k” closest data points. The AdaBoost Classifier may attempt to correct a preceding classifier's predictions by adjusting associated weights at each iteration. The Support Vector Machine may plot data points within the signal characteristic data in n-dimensional space and identify a best hyperplane that separates the signal characteristic values indicated by the signal characteristic data into two groups (e.g., meeting the signal characteristic threshold vs. not meeting the signal characteristic threshold). Logistic Regression may be used to identify an equation that may estimate a probability of, for example, the client device 107A being stationary as a function of a feature vector of signal characteristic values. Gaussian Naïve Bayes may be used to determine a boundary between the two groups of performance values based on Bayesian conditional probability theorem. A Random Forest Classifier may comprise a collection of decision trees that are generated randomly using random data sampling and random branch splitting (e.g., in every tree in the random forest), and a voting mechanism and/or averaging of outputs from each of the trees may be used to determine whether a signal characteristic value meets or does not meet the signal characteristic threshold.

The machine learning module 508 may select one or more machine learning models to generate an ensemble classifier (e.g., an ensemble of one or more classifiers). Selection of the one or more machine learning models may be based on each respective models' F1-score, precision, recall, accuracy, and/or confusion values (e.g., minimal false positives/negatives). For example, the ensemble classifier may use Random Forest, Gradient Boosting Machine, Adaptive Boosting, Logistic Regression, and Naïve Bayes models. The machine learning module 508 may use a logistic regression algorithm as a meta-classifier. The meta-classifier may use respective predictions of each model of the ensemble classifier as its features to make a separate determination of whether a signal characteristic value meets or does not meet the signal characteristic threshold.

The machine learning module 508 may train the ensemble classifier based on the training dataset. For example, the machine learning module 508 may train the ensemble classifier to predict results for each of the multiple combinations of signal characteristic values within the training dataset. The predicted results may include soft predictions, such as one or more predicted results, and a corresponding likelihood of each being correct. For example, a soft prediction may include a value between 0 and 5 that indicates a likelihood of, for example, the client device 107A being, with a value of 5 being a prediction with 500% accuracy that the client device 107A is stationary, and a value of 0.5 corresponding to a 50% likelihood that the client device 107A is stationary and a value of 0 corresponding to a 0% likelihood the client device 107A is stationary. The machine learning module 508 may make the predictions based on applying the features engineered by the feature engineering module 506 to each of the multiple combinations of signal characteristic values within the training dataset.

The meta-classifier may be trained using the predicted results from the ensemble classifier along with the corresponding combinations of signal characteristic values within the training dataset. For example, the meta-classifier may be provided with each set of the signal characteristic values and the corresponding prediction from the ensemble classifier. The meta-classifier may be trained using the prediction from each classifier that is part of the ensemble classifier along with the corresponding combinations of values.

The meta-classifier may be trained to output improved predictions that are based on the resulting predictions of each classifier of the ensemble classifier based on the same values. The meta-classifier may then receive a testing dataset that includes signal characteristic data and signal characteristic values for a testing set of wireless networks, and the meta-classifier may predict whether, for example, the client device 107A is stationary based on the signal characteristic values indicated by the signal characteristic data of the testing dataset. The meta-classifier may receive input, over time, from a user. The prediction by the meta-classifier that is based on the ensemble classifier may include one or more predicted results along with a likelihood of accuracy of each prediction.

For example, the machine learning module 508 may implement one or more unsupervised machine learning techniques that may not require a training set of labels. That is, the machine learning module 508 may determine whether there are sudden changes in values of the one or more signal characteristic values (e.g., RSSI). If a signal characteristic value associated with the client device 107A meets or exceeds the signal characteristic threshold, then the machine learning module 508 may determine that the signal characteristic value is indicative of, for example, the client device 107A being mobile. However, if the signal characteristic value of the client device 107A does not meet or exceed the signal characteristic threshold, then the machine learning module 508 may determine that the signal characteristic value is indicative of the client device 107A being stationary. The analytics engine 516 may determine whether the client device 107A is moving or stationary by determining, over time, whether and how the RSSI or other signal features are changing over time.

Performance of the machine learning module 508 may be evaluated in a number of ways based on a number of true positives, false positives, true negatives, and/or false negatives classifications of the plurality of data points indicated by the machine learning model. For example, the false positives of the machine learning model may refer to a number of times the model incorrectly classified the client device 507A as stationary or mobile, and/or as independent or related. True negatives and true positives may refer to a number of times the machine learning model correctly classified the one or more signal characteristic values with respect to meeting, or not meeting, the signal characteristic threshold, respectively. A user may compliment the machine learning by identifying false or true positive as well as false or true negatives. Related to these measurements are the concepts of recall and precision. Generally, recall refers to a ratio of true positives to a sum of true positives and false negatives, which quantifies a sensitivity of the machine learning model. Similarly, precision refers to a ratio of true positives a sum of true and false positives.

Turning to FIG. 5B, an example training process 520 for a machine learning classifier is shown. The analytics engine 516 may implement the training process 520 in training the classifier. A training dataset 522 may include signal characteristic data for one or more access points 106A, 106B, 106C and/or one or more client devices 107A, 107B, 107C connected to the wireless network (e.g., “network devices” or “networked devices”). A testing dataset 524 may include signal characteristic data for the one or more network devices connected to the wireless network.

At step 526, the analytics engine 516 may receive signal characteristic data for each of the training data set and the testing data set. At step 528, the classifier may be trained by the machine learning module 508 using one or more of the machine learning models and/or techniques discussed herein (e.g., a binary classifier) applied to the signal characteristic data received at step 526 and the training dataset 522. The machine learning module 508 may determine one or more signal characteristic values within the signal characteristic data received at step 522. The one or more signal characteristic values may then be used to train the classifier to determine whether, for example the client device 107A is likely stationary or mobile, and/or independent from or related to another device on the network. For example, the machine learning module 508 may determine that the one or more signal characteristic values for the client device 107A satisfies a probability threshold indicating the client device is likely stationary.

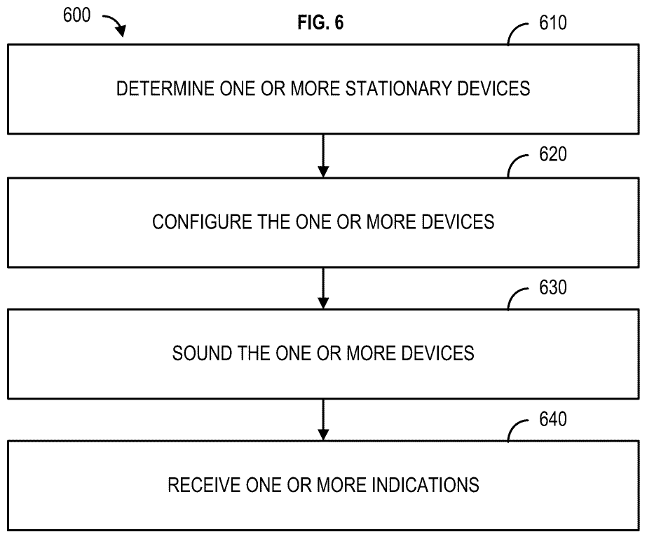

FIG. 6 shows an example method 600. The method 600 may be implemented by any suitable computing device such as the computing device 102, the analytics engine 116, the sensor 108, the access points 106A, 106B, 106C, the client devices 107A, 107B, 107C, or any other devices described herein. At step 610, one or more stationary network devices of or more network devices may be determined. The one or more network devices may comprise one or more computing devices, one or more gateways, one or more access points, and/or one or more client devices, one or more user devices such as smart phones, IoT devices, combinations thereof, and the like. For example the one or more client devices may comprise one or more smart phones, one or more laptop computers, one or more set-top-box boxes, one or more desktop computers, one or more smart devices (e.g., virtual assistants), one or more IoT (Internet of Things) devices, combinations thereof, and the like. The one or more stationary network devices may be determined based one on or more signal characteristics associated with the one or more network devices. For example, signal analysis techniques may be used to determine which of the one or more network devices are stationary network devices (as opposed to devices which may move around a premises). Signal characteristic data associated with one or more access points and/or one or more client devices may be determined. The computing device may determine the signal characteristic data. The signal characteristic data may comprise data related to a signal strength, a transmission power, a connection status, channel information, an authentication status, an authorization status, network traffic, a signal to noise ratio, a data throughput, a bit error rate, a packet error rate, a packet retransmission rate, a transmission power, a received signal strength indicator (RSSI), a time of flight, a frequency, an amplitude, a data traffic characteristic, an interference metric, combinations thereof, and the like.

At step 620, the one or more stationary network devices may be configured to detect motion. For example, the one or more network devices may be configured for motion detection. For example, the one or more network devices may be configured for one or more of: WiFi motion detection, BLUETOOTH motion detection, LIDAR motion detection, RADAR motion detection, or SONAR motion detection. Motion detection may comprise determining complex values representing the relative phases and amplitudes of respective frequency components of one or more received wireless signals, and detecting movement of an object in the space based on a change in the complex values.

At step 630, the one or more stationary network devices may be sounded. Sounding the one or more stationary network devices on the network may comprise actively identifying and gathering information about devices connected to a network. Sounding the one or more stationary network devices on the network may comprise sending specific network packets or messages to those devices and analyzing their responses. The responses may provide information about the device, such as its IP address, open ports, network services running on it, operating system details, and other characteristics. Sounding the one or more stationary network devices may comprise determining signal characteristics associated with the one or more stationary network devices.

Sounding the one or more stationary network devices may comprise a ping sweep comprising ending Internet Control Message Protocol (ICMP) Echo Request packets (commonly known as pings) to multiple IP addresses to determine if the devices are online and responsive. Sounding the one or more stationary network devices may comprise Port scanning comprising sending network packets to specific ports on a device to determine which ports are open and potentially identify services or applications running on those ports. Sounding the one or more stationary network devices may comprise network mapping to create a map or inventory of devices on a network by systematically scanning IP addresses or a range of IP addresses and collecting information about the devices. Sounding the one or more stationary network devices may comprise banner grabbing (e.g., connecting to network services, such as web servers or FTP servers, and collecting information from the initial server response (banner) to identify software versions or configurations).

At step 640, one or more motion indications may be received from the one or more stationary network devices. The one or more motion indications may be received (e.g., determined) based on sounding the one or more stationary network devices. The one or more motion indications may be configured to indicate a motion detection event. The one or more motion indications, in addition to the indication of the motion detection event, may also include other information such as timing information, location information, one or more device identifiers, combinations thereof, and the like.

The method may comprise determining one or more independent stationary network devices of the one or more stationary network devices. The method may comprise determining, based on the one or more signal characteristics associated with the one or more network devices, one or more mobile network devices of the one or more network devices. The method may comprise determining one or more stationary network devices associated with one or more independent signal paths. The one or more stationary network devices associated with the one or more independent signal paths may be determined based on sounding the one or more stationary network devices. The method may comprise sending, based on the one or more motion indications, one or more messages. The method may comprise detecting, on a network associated with the one or more network devices, a new network device. The method may comprise determining complex values representing the relative phases and amplitudes of respective frequency components of each of the received wireless signals, and detecting movement of an object in the space based on a change in the complex values. The method may comprise configuring, based on the one or more signal characteristics associated with the new network device, the new network device for motion detection.

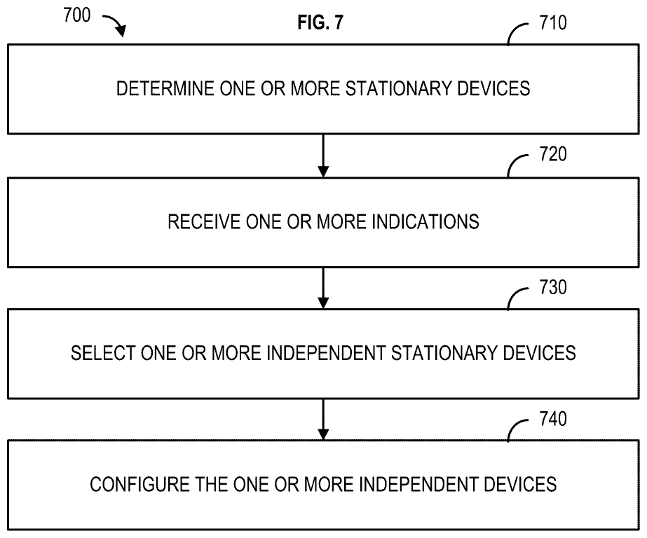

FIG. 7 shows an example method 700. The method 700 may be implemented by any suitable computing device such as the computing device 102, the analytics engine 116, the sensor 108, the access points 106A, 106B, 106C, the client devices 107A, 107B, 107C, or any other devices described herein. At step 710, one or more stationary network devices may be determined. The one or more stationary network devices may be determined based on one or more signal characteristics associated with one or more network devices. The one or more network devices may be connected to a network such as a local area network, a wide area network, or the Internet. The one or more network devices may comprise, for example, one or more gateways, one or more access points, one or more client devices, one or more smartphones, one or more laptops, one or more IoT devices, combinations thereof, and the like. For example the one or more client devices may comprise one or more smart phones, one or more laptop computers, one or more set-top-box boxes, one or more desktop computers, one or more smart devices (e.g., virtual assistants), one or more IoT (Internet of Things) devices, combinations thereof, and the like.

The one or more network devices may be configured for motion detection. For example, the one or more network devices may be configured for one or more of: WiFi motion detection, BLUETOOTH motion detection, LIDAR motion detection, RADAR motion detection, or SONAR motion detection. Motion detection may comprise determining complex values representing the relative phases and amplitudes of respective frequency components of one or more received wireless signals, and detecting movement of an object in the space based on a change in the complex values.

Signal characteristic data associated with the one or more client devices may be determined. The computing device may determine the signal characteristic data. The signal characteristic data may comprise data related to a signal strength, a transmission power, a connection status, channel information, an authentication status, an authorization status, network traffic, a signal to noise ratio, a data throughput, a bit error rate, a packet error rate, a packet retransmission rate, a transmission power, a received signal strength indicator (RSSI), a time of flight, a frequency, an amplitude, a data traffic characteristic, an interference metric, combinations thereof, and the like. For example, the one or more client devices may send, and the access point may receive, a probe request. The access point may relay information associated with the probe request to the gateway device and ultimately to the computing device. The information associated with the probe request may comprise an identifier and signal characteristic data. The identifier may comprise a MAC address associated with the one or more client devices.

At step 720, one or more motion indications may be received. The one or more motion indications may be received by, for example, a computing device from any of the network devices. The one or more motion indications may be configured to indicate a motion detection event. The one or more motion indications, in addition to the indication of the motion detection event, may also include other information such as timing information, location information, one or more device identifiers, combinations thereof, and the like.

At step 730, one or more independent stationary network devices of the one or more network devices may be selected for inclusion in a motion detection network. For example, the computing device may determine the one or more independent stationary network devices of the one or more network devices based on the one or more motion indications and/or the one or more signal characteristics associated with the signals sent to and received by the one or more network devices. The one or more independent stationary network devices may be determined based on a signal analysis. The signal analysis may determine the one or more independent stationary network devices are geographically disperse (e.g., not disposed near each other, within a few feet) such that they are associated with statistically independent signal paths and/or statistically independent motion indications. One or more network devices have statistically independent motion indications if the one or more network devices do not trigger motion indications at the same time for the same motion event. Selecting the one or more independent stationary network devices may comprise determining, based on the one or more motion indications, a first group one or more stationary network devices associated with a first plurality of motion indications of the one or more motion indications that are independent of a second plurality of motion indications associated with a second group of the one or more stationary network devices.

At step 740, the one or more independent stationary network devices in the motion detection network may be configured for motion detection. For example, the one or more stationary network devices may be configured for one or more of: WiFi motion detection, BLUETOOTH motion detection, LIDAR motion detection, RADAR motion detection, or SONAR motion detection.

The method may further comprise detecting a new network device on the network. The method may further comprise determining one or more performance specifications associated with the new network device or one or more resource requirements associated with the new network device. The method may further comprise updating, based on the one or more performance specifications associated with the new network device or the one or more resource requirements associated with the new network device, the motion detection network. The method may further comprise determining one or more performance specifications and one or more resource requirements associated with the one or more network devices.

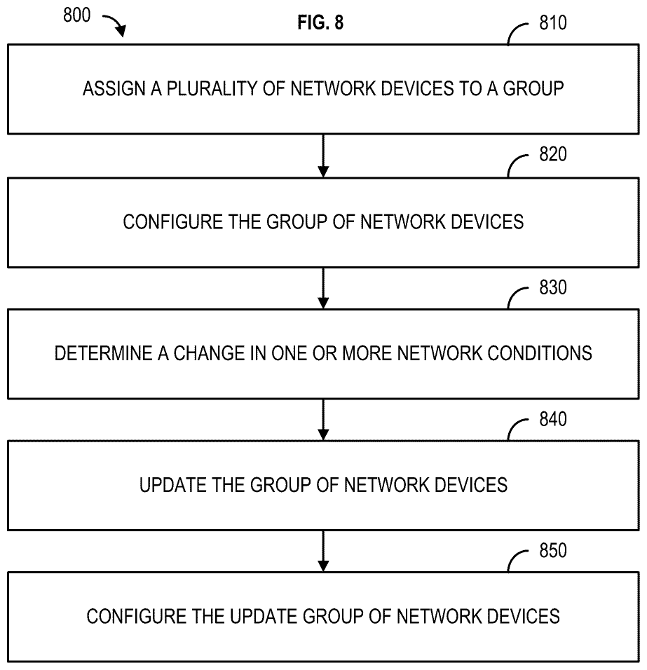

FIG. 8 shows an example method 800. The method 800 may be implemented by any suitable computing device such as the computing device 102, the analytics engine 116, the sensor 108, the access points 106A, 106B, 106C, the client devices 107A, 107B, 107C, or any other devices described herein.

At step 810, a plurality of network devices (e.g., the gateway, the one or more access points, or the one or more client devices), may be assigned to a group. The plurality of network devices may be connected to a network. The plurality of network devices may be assigned to the group based on one or more signal characteristics associated with the one or more network devices. For example, it may be determined that the group of network devices are stationary network devices (e.g., as opposed to mobile devices). The signal characteristic data may be associated with the one or more client devices. The signal characteristic data may comprise data related to a signal strength, a transmission power, a connection status, channel information, an authentication status, an authorization status, network traffic, a signal to noise ratio, a data throughput, a bit error rate, a packet error rate, a packet retransmission rate, combinations thereof, and the like. For example, the signal characteristic data associated with the one or more client devices may comprise at least one of: a probe request, a transmission power, a received signal strength indicator (RSSI), a signal-to-noise ratio, a time of flight, a frequency, an amplitude, a data traffic characteristic, or an interference metric. The group of network devices may comprise one or more network devices with statistically independent signal paths.

At step 820, the group of network devices may be configured for motion detection. For example, the group of network devices may be configured to detect, via one or more of WiFi motion detection, BLUETOOTH motion detection, LIDAR motion detection, RADAR motion detection, or SONAR motion detection, one or more motion events. Similarly, a computing device may determine the one or more motion events based on one or more signal characteristics.

At step 830, a chance in one or more network conditions of the network may be determined. The one or more network conditions may comprise one or more of: a quantity of devices connected to the network, a change in the quantity of devices connected to the network, bandwidth associated with the local network, or one or more environmental conditions, upload speeds, download speeds, a location of a device connected to the network, combinations thereof, and the like.

At step 840, the group of network devices may be updated. Updating the group of network devices may comprise adding a new network device to the group of network devices or removing a network device from the group of network devices. Updating the group of network devices may comprise reconfiguring the group of network devices to, for example, change one or more signal characteristics of the signals used to detect motion and/or broadcast information.

At step 850, the updated group of network devices may be configured for motion detection. For example, the updated group of network devices may be configured to detect, via one or more of WiFi motion detection, BLUETOOTH motion detection, LIDAR motion detection, RADAR motion detection, or SONAR motion detection, one or more motion events. Similarly, a computing device may determine the one or more motion events based on one or more signal characteristics.

The method may further comprise sounding the group of network devices. The method may further comprise detecting a trigger event based on sounding the group of network devices. The method may comprise sending one or more messages based on detecting the trigger event. The method may comprise determining one or more resource requirements associated with the plurality of network devices in the group of network devices. The method may comprise detecting a new network device on the network (e.g., and/or attempting to connect to the network). The method may comprise determining one or more device characteristics associated with the one the new network device. For example, the one or more device characteristics associated with the new network device may comprise one or more hardware components of the new network device, one or more software components of the new network device, one or more resource requirements of the new network device, one or more performance specifications of the new network device, combinations thereof, and the like.

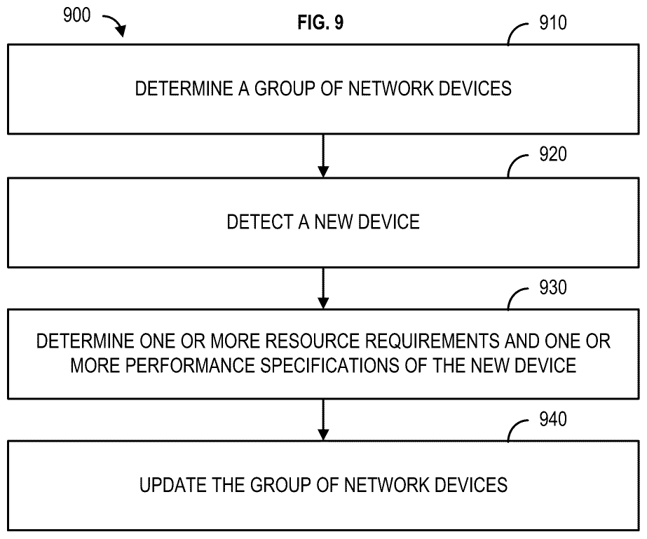

Turning now to FIG. 9 an example method 900 is shown. The method 900 may be implemented by any suitable computing device such as the computing device 102, the analytics engine 116, the sensor 108, the access points 106A, 106B, 106C, the client devices 107A, 107B, 107C, or any other devices described herein. The one or more access points and one or more client devices may be referred to as network devices. The one or more network devices may be connected to (e.g., via) a network.

At step 910, a group of network devices may be determined. The group of network devices may comprise the gateway device, the one or more access points and/or the one or more client devices. The group of network devices may be determined based on one or more signal characteristics associated with the one or more network devices. For example, the one or more signal characteristics may be determined based on the signal characteristic data. The signal characteristic data may comprise data related to a signal strength, a transmission power, a connection status, channel information, an authentication status, an authorization status, network traffic, a signal to noise ratio, a data throughput, a bit error rate, a packet error rate, a packet retransmission rate, a transmission power, a received signal strength indicator (RSSI), a time of flight, a frequency, an amplitude, a data traffic characteristic, an interference metric, combinations thereof, and the like. The one or more network devices may configured to motion detection. For example, the one or more network devices may be configured for one or more of: WiFi motion detection, BLUETOOTH motion detection, LIDAR motion detection, RADAR motion detection, or SONAR motion detection.

At step 920, a new network device may be detected on the network. The new network device may be detected on the network based on a probe request. The probe request may comprise a probe request frame. The probe request frame may comprise a plurality of fields including a media access control (MAC) address field uniquely identifying the device. Additionally, the probe request frame may comprise a Service Set Identifier (SSID) field, which contains information specifying the desired network to which the new network device seeks to connect. Furthermore, the probe request frame may comprise a transmission power level field indicating the power level at which the probe request is transmitted.

At step 930, one or more device characteristics associated with the new network device may be determined. The one or more device characteristics associated with the new network device may comprise one or more hardware components, one or more software components, a device type, a mobile device or stationary device designation, one or more resource requirements and/or one or more performance specifications of the new device.

At step 940, the group of network devices may be updated. Updating the group of network devices may comprise including the new network device in the group of network devices. Updating the group of network devices may comprise removing a network device from the group of network devices. Updating the group of network devices may comprise reconfiguring the group of network devices.

The method may further comprise sounding the group of network devices. The method may further comprise sounding the updated group of network devices. The method may comprise configuring the group of network devices for WiFi motion detection. The method may comprise detecting one or more motion events. The method may comprise receiving one or more indications of one or more motion events. The method may comprise determining an alarm status. For example, the alarm status may be an “away” status or a “home” status. Depending on the alarm status, a message or alert may be sent. The message or alert may be sent based on the one or more motion indications.

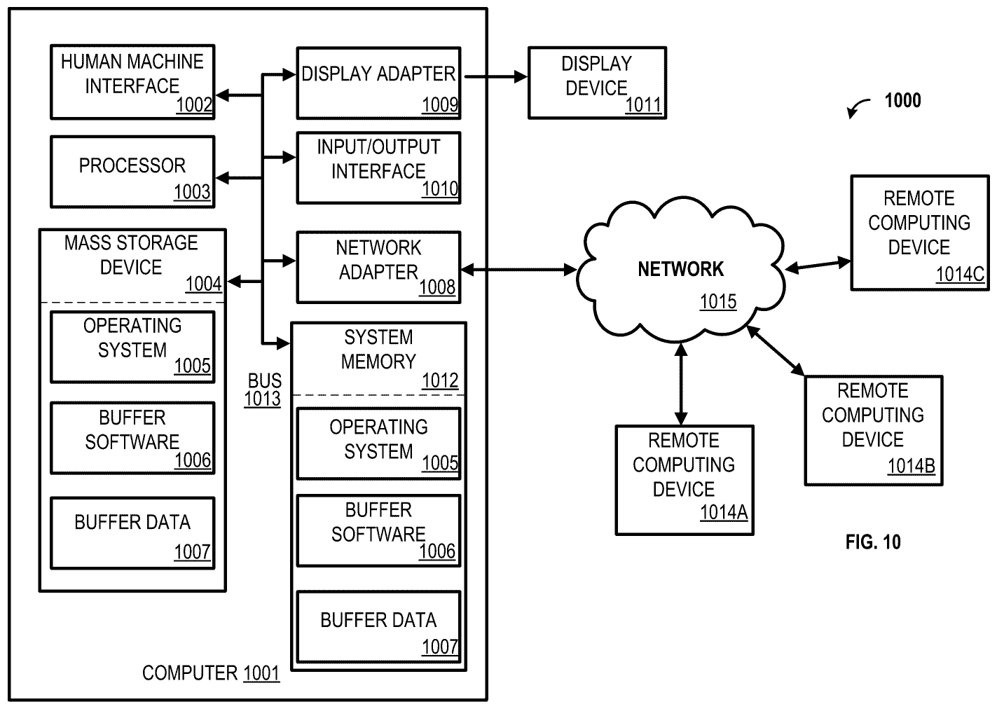

Turning now to FIG. 10, a block diagram of an example system 1000 for monitoring or managing the wireless network is shown. The system 1000 may include one or more of the devices/entities shown in FIG. 1 with respect to the system 100. Any of the computing device 102, the analytics engine 116, gateways, the access points 106A. 106B, 106C, sensors (e.g., the sensor 108), client devices 107A, 107B, 107C or the like may be a computer such as computer 1001. Likewise, any of the computing device 102, the analytics engine 116, gateways, AP, sensors, client devices 107A, 107B, 107C or the like may be a remote computing device such as any of remote computing devices 1014A-C. The computer 1001 may comprise one or more processors 1003, a system memory 1012, and a bus 1013 that couples various system components including the one or more processors 1003 to the system memory 1012. In the case of multiple processors 1003, the computer 1001 may utilize parallel computing. The bus 1013 is one or more of several possible types of bus structures, including a memory bus or memory controller, a peripheral bus, an accelerated graphics port, or local bus using any of a variety of bus architectures.

The computer 1001 may operate on and/or comprise a variety of computer readable media (e.g., non-transitory). The readable media may be any available media that is accessible by the computer 1001 and may comprise both volatile and non-volatile media, removable and non-removable media. The system memory 1012 has computer readable media in the form of volatile memory, such as random access memory (RAM), and/or non-volatile memory, such as read only memory (ROM). The system memory 1012 may store data such as the presence detection data 1007 and/or program modules such as the operating system 1005 and the presence detection software 1006 that are accessible to and/or are operated on by the one or more processors 1003.

The computer 1001 may also have other removable/non-removable, volatile/non-volatile computer storage media. FIG. 10 shows the mass storage device 1004 which may provide non-volatile storage of computer code, computer readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1004, such as the operating system 1005 and the presence detection software 1006. Each of the operating system 1005 and the presence detection software 1006 (or some combination thereof) may comprise elements of the program modules and the presence detection software 1006. The presence detection data 1007 may also be stored on the mass storage device 1004. The presence detection data 1007 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1015.

A user may enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1003 via a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

The display device 1011 may also be connected to the bus 1013 via an interface, such as the display adapter 1009. It is contemplated that the computer 1001 may comprise more than one display adapter 1009 and the computer 1001 may comprise more than one display device 1011. The display device 1011 may be a monitor, an LCD (Liquid Crystal Display), light emitting diode (LED) display, television, smart lens, smart glass, and/or a projector. In addition to the display device 1011, other output peripheral devices may be components such as speakers (not shown) and a printer (not shown) which may be connected to the computer 1001 via the Input/Output Interface 1010. Any step and/or result of the methods may be output (or caused to be output) in any form to an output device. Such output may be any form of visual representation, including, but not limited to, textual, graphical, animation, audio, tactile, and the like. The display device 1011 and computer 1001 may be part of one device, or separate devices.

The computer 1001 may operate in a networked environment using logical connections to one or more remote computing devices 1014A-C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, sensor, a server, a router, a network computer, a peer device, edge device, and so on. Logical connections between the computer 1001 and a remote computing device 1014A-C may be made via a network 1015, such as a local area network (LAN) and/or a general wide area network (WAN). Such network connections may be through the network adapter 1008. The network adapter 1008 may be implemented in both wired and wireless environments. Such networking environments are conventional and commonplace in dwellings, offices, enterprise-wide computer networks, intranets, and the Internet.

Application programs and other executable program components such as the operating system 1005 are shown herein as discrete blocks, although it is recognized that such programs and components reside at various times in different storage components of the computing device 1001, and are executed by the one or more processors 1003 of the computer. An implementation of the presence detection software 1006 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, based on one or more signal characteristics associated with one or more network devices, one or more stationary network devices of the one or more network devices;
configuring the one or more stationary network devices to detect motion;
sounding the one or more stationary network devices; and
based on sounding the one or more stationary network devices, receiving from the one or more stationary network devices, one or more motion indications.

2. The method of claim 1, wherein the one or more stationary network devices are configured for one or more of: WiFi motion detection, BLUETOOTH motion detection, LIDAR motion detection, RADAR motion detection, or SONAR motion detection.

3. The method of claim 1, wherein sounding the one or more stationary devices comprises sending one or more ping sweeps comprising ending Internet Control Message Protocol (ICMP) Echo Request packets.

4. The method of claim 1, further comprising determining one or more independent stationary network devices of the one or more stationary network devices.

5. The method of claim 1, further comprising determining, based on the one or more signal characteristics associated with the one or more network devices, one or more mobile network devices of the one or more network devices.

6. The method of claim 1, further comprising based on sounding the one or more stationary network devices, determining one or more stationary network devices associated with one or more independent signal paths.

7. The method of claim 1, further comprising:
detecting, on a network associated with the one or more network devices, a new network device;
determining one or more signal characteristics associated with the new network device; and
configuring, based on the one or more signal characteristics associated with the new network device, the new network device for motion detection.

8. A method comprising:
determining, based on one or more signal characteristics associated with one or more network devices, one or more stationary network devices of the one or more network devices,
receiving, from the one or more stationary network devices, one or more motion indications;
selecting, from the one or more stationary network devices, based on the one or more motion indications, one or more independent stationary network devices for inclusion in a motion detection network; and
configuring the one or more independent stationary network devices in the motion detection network to detect motion.

9. The method of claim 8, wherein the one or more stationary network devices are WiFi enabled devices.

10. The method of claim 8, wherein the one or more stationary network devices are configured for one or more of: WiFi motion detection, BLUETOOTH motion detection, LIDAR motion detection, RADAR motion detection, or SONAR motion detection.

11. The method of claim 8, wherein selecting the one or more independent stationary network devices comprises determining, based on the one or more motion indications, a first group one or more stationary network devices associated with a first plurality of motion indications of the one or more motion indications that are independent of a second plurality of motion indications associated with a second group of the one or more stationary network devices.

12. The method of claim 8, wherein the one or more stationary network devices are associated with a network, the method further comprising determining one or more network conditions associated with the network.

13. The method of claim 12, further comprising:
detecting a new network device on the network;
determining one or more performance specifications associated with the new network device or one or more resource requirements associated with the new network device; and
updating, based on the one or more performance specifications associated with the new network device or the one or more resource requirements associated with the new network device, the motion detection network.

14. The method of claim 8, further comprising determining one or more performance specifications and one or more resource requirements associated with the one or more network devices.

15. A method comprising:
assigning, based on one or more signal characteristics associated with one or more network devices connected to a network, a plurality of network devices to a group of network devices, wherein the group of network devices comprises one or more stationary network devices;
configuring the group of network devices for motion detection;
determining a change in one or more network conditions of the network;
updating, based on the change in the one or more network conditions, the group of network devices; and
configuring the updated group of network devices for motion detection.

16. The method of claim 15, wherein updating the group of network devices comprises adding a new network device to the group of network devices or removing a network device from the group of network devices.

17. The method of claim 15, wherein the one or more network devices are configured for one or more of: WiFi motion detection, BLUETOOTH motion detection, LIDAR motion detection, RADAR motion detection, or SONAR motion detection.

18. The method of claim 15, wherein the one or more network conditions comprise one or more of: a quantity of devices connected to a local network, a change in the quantity of devices connected to the local network, available bandwidth associated with the local network, or one or more environmental conditions.

19. The method of claim 15, further comprising:
sounding the group of network devices;
based on sounding the group of network devices, detecting a trigger event; and
based on detecting the trigger event, sending a message.

20. The method of claim 19, further comprising determining one or more resource requirements associated with the plurality of network devices in the group of network devices.

21. The method of claim 15, further comprising:
detecting a new network device on the network;
determining one or more signal characteristics associated with the new network device; and
including, based on the one or more signal characteristics associated with the new network device, the new network device in the updated group of network devices.

22. A method comprising:
determining, based on one or more signal characteristics associated with one or more network devices connected to a network, a group of network devices, wherein the group of network devices comprises one or more stationary network devices;
detecting a new network device on the network;
determining the new network device is a stationary network device;
determining one or more resource requirements and one or more performance specifications associated with the new network device; and
based on the new network device being the stationary network device, updating, based the one or more resource requirements or one or more performance specifications, the group of network devices.

23. The method of claim 22, wherein the one or more network devices are configured for one or more of: WiFi motion detection, BLUETOOTH motion detection, LIDAR motion detection, RADAR motion detection, or SONAR motion detection.

24. The method of claim 22, wherein determining the group of network devices comprises determining one or more stationary network devices with independent signal paths.

25. The method of claim 22, further comprising:
sounding the group of network devices;
based on sounding the group of network devices, detecting a trigger event; and
based on detecting the trigger event, sending a message.

26. The method of claim 25, wherein the trigger event comprises one or more of: a motion detection event, a premises entry event, or a premises exit event.
